(19) United States
(12) Patent Application Publication
(10) Pub. No.: US 2026/0228132 A1
(43) Pub. Date: Aug. 6, 2026

(54) MEMORY DEVICE AND A PROCESSOR FOR MEMORY FRESHNESS

(71) Applicant: Intel Corporation, Santa Clara, CA (US)

(72) Inventors: Scott CONSTABLE, Portland, OR (US); Simon P. JOHNSON, Beaverton, OR (US); Fangfei LIU, Hillsboro, OR (US); Raghunandan MAKARAM, Northborough, MA (US); Thomas UNTERLUGGAUER, Villach (AT)

(21) Appl. No.: 19/630,585

(22) Filed: Mar. 27, 2026

(51) Int. Cl. G06F 12/0897; G06F 12/0831; G06F 12/0891

(52) U.S. Cl. CPC G06F 12/0897; G06F 12/0831; G06F 12/0891

(57) ABSTRACT

A memory device includes: a memory array configured to store data, and a control circuit coupled to the memory array and configured to, in response to a read operation targeting data for which a read-once indicator associated with the data stored in the memory array is set: output the data, and render the data unavailable for a subsequent read operation.

### BACKGROUND

Modern computing systems operate on the assumption that data written to a memory device by a processor (e.g., to an external memory device) can be reliably retrieved in its most recently written form. This assumption underlies the correctness of any workload that writes data to memory and the same or another workload that subsequently reads that data back. The physical and functional separation between a processor and an external memory device introduces a vulnerability surface.

For data to be processed in any manner, data must traverse an interface (i.e., a physical interface, such a bus) that lies outside the processor's trust boundary, and commands issued over that bus are subject to interference from hardware interposed between the processor and the memory device. A processor cannot directly observe whether a write command transmitted over the memory interface was executed by the memory device, and conventional memory devices provide no mechanism by which the processor could detect that a write was not committed.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 illustrates a block diagram of an example memory system;

FIG. 3 illustrates a schematic diagram of an example system in accordance with various aspects described herein;

FIG. 4 illustrates an example flow in accordance with various aspects described herein;

FIG. 5 illustrates an example flow in accordance with various aspects described herein;

FIG. 6 shows an example of a method;

FIG. 7 shows an example of a method.

### DESCRIPTION

The present disclosure relates to memory systems in computing devices, and more particularly to techniques for controlling read semantics of data stored in memory and for adapting processor cache management to enforce freshness of data in external memory devices.

Conventional approaches to memory integrity employ checksums, error-correcting codes, or message authentication codes computed over stored data. These mechanisms can detect corruption of data already resident in memory, which involves modifications to data after it has been written. A distinct class of integrity failure arises when data in memory, that may be seen as authentic and uncorrupted, but it is not the most recently written version, because a more recent write was not committed to the memory device. This condition, that may be referred to herein as staleness, is not detectable by authentication mechanisms alone. Because, a stale copy of data may pass all integrity checks while representing an outdated state. In various aspects, addressing staleness may require that the memory device and the processor cooperate. For example, the memory device must be capable of enforcing access policies that make stale data unavailable, and the processor must manage its cache hierarchy in a manner that ensures the memory device always holds a current copy when no cached copy exists.

Trusted Execution Environments (TEEs) are hardware-enforced security architectures that isolate the execution of sensitive workloads from access by privileged software and physical adversaries. For example, Intel SGX can implement TEEs in the form of enclaves, and Intel TDX can implement TEEs in the form of Trust Domains. These architectures may rely on memory encryption. This may include that data is encrypted by the processor before being written to external memory and decrypted upon retrieval, which may result in protecting confidentiality against entities that can observe the memory bus or DRAM contents.

Furthermore, some types of processors (e.g., Intel Scalable Xeon) may additionally support various memory integrity modes applicable to TEE memory. For example, Logical Integrity employs a TEE Owner bit stored in the ECC area of the memory device to prevent consumption of TEE ciphertext by entities outside the originating TEE instance. Furthermore, Cryptographic Integrity extends Logical Integrity by adding a message authentication code computed over data and associated metadata, providing cryptographic defense against software-based tampering attacks such as Rowhammer and certain hardware-based corruption. An earlier approach, may involve using a Memory Encryption Engine incorporating a Merkle tree to enforce freshness of enclave memory, protecting against replay attacks and dropped writes. The Merkle tree approach could not scale to the gigabytes of memory required by server products.

Despite its advantages in terms of security, there are hardware-based attacks that may not be mitigated by Cryptographic Integrity. For example, an attack can employ a physical device inserted between the processor memory controller and the memory device on the memory bus, such as a memory interposer, to interfere with command signals. The capability of the class of interposers relevant to this attack can be limited to holding individual bus signals high or low for a period spanning multiple clock cycles. This capability is sufficient to cause the memory device to ignore write commands selectively chosen by the attacker, which corresponds to a condition referred to herein as a dropped write. From the processor's perspective, the write command was issued and no error was reported. Correspondingly, the processor can proceed under the assumption that the written data is now resident in the memory device. From the memory device's perspective, the write command was not received, and the memory device retains whatever data was previously stored at the targeted address. When the processor subsequently issues a read to that address, the memory device returns the stale, pre-write data. The stale data can carry a valid message authentication code and a valid TEE Owner bit, because it was authentically written in a prior operation. Consequently, neither Logical Integrity nor Cryptographic Integrity techniques may be able to detect the staleness condition, and the TEE instance can consume data that does not reflect the most recent write.

To summarize, certain memory integrity modes, such as Cryptographic Integrity, detects post-write tampering but they cannot detect the absence of a committed write where the write command was corrupted such that the memory device discarded accompanying data without storing it. Various memory integrity modes, such as the Merkle tree, may have certain features towards freshness but they are abandoned for various reasons, such as scalability. There is no mechanism in memory integrity modes that tracks whether data in the memory device reflects the most recent write issued by the processor. A freshness enforcement mechanism that operates within commodity DRAM and server processor architectures, without requiring a Merkle tree or equivalent hierarchical integrity structure, may be desirable. Various aspects described herein can address this requirement through changes to one or both the memory device and the processor. For example, the memory device can enforce read-once semantics on designated data, and the processor may adapt its cache management to ensure that valid data is always returned to the memory device upon eviction. The combination can enforce a mutual exclusion invariant under which stale data cannot be consumed by a consumer (e.g., a TEE instance) even when writes are dropped by an attacker.

A trusted execution environment (TEE), as described herein, may refer to a hardware-enforced isolated execution environment that is configured to protect the confidentiality and integrity of code and data executing within the environment against access by privileged software, including operating systems and hypervisors, and against physical adversaries with access to the hardware platform. An enclave refers to a TEE instance, in certain methods, consisting of protected memory pages whose contents are encrypted and integrity-protected by the processor. The enclave's code and data are configured to be inaccessible to software executing outside the enclave boundary. A trust domain refers to a TEE instance, in various other methods, at virtual machine granularity, providing hardware-enforced isolation for an entire virtual machine and its associated memory. Both enclaves and trust domains rely on memory encryption to protect data written to external memory. The terms "enclave" and "trust domain" may be used herein to refer to these respective TEE instances.

Memory encryption may refer to the process by which a processor encrypts data before writing the data to an external memory device and decrypts the data upon reading the data back from the external memory device. The purpose of memory encryption includes protecting the confidentiality of data against entities that can observe or access the physical memory bus or the memory device itself, such as a memory interposer or a physical adversary with direct hardware access. Memory encryption may be applied transparently to the software executing within the TEE instance. For example, the software operates on plaintext within the processor and the encrypted form is present only in external memory. Traditional memory encryption alone does not ensure that the plaintext reconstructed on a read corresponds to the most recently written version of the data, considering that an entity that causes an earlier ciphertext to be present at a memory address will obtain, upon decryption, the plaintext corresponding to that earlier write rather than the most recent write.

Logical Integrity, as used herein, may refer to a memory integrity mode in which a TEE Owner bit is stored in the ECC area of the memory device in association with each protected data unit. The TEE Owner bit identifies the TEE instance that wrote the data and prevents software executing in a different security domain from consuming ciphertext belonging to another domain. Cryptographic Integrity, as used herein, may refer to a memory integrity mode that extends Logical Integrity by adding a message authentication code computed over the data and associated metadata. Cryptographic Integrity provides cryptographic detection of post-write data modifications, including software-based attacks such as Rowhammer and certain hardware-based corruption events.

A cache line, as described herein, may refer to the fundamental unit of data transfer between the processor cache hierarchy and the memory device that is external to the processor (which may be referred to as external memory device herein). A cache line may include (e.g., consist of) a fixed-width contiguous block of data, typically 64 bytes, together with associated metadata maintained both within the cache hierarchy and within the memory device at the same granularity. All read and write operations between the processor and the external memory device are performed at cache line granularity. For example, the processor fetches an entire cache line on a cache miss and writes back an entire cache line on eviction. Metadata associated with a cache line, including ECC data and security attributes such as the TEE Owner bit, may be maintained and transferred at this same granularity. The 64-byte cache line can be the preferred granularity for read-once indicator and validity indicator related aspects as described herein.

A cache hierarchy, as described herein, may refer to a multi-level structure of cache memories internal to the processor through which data passes between processing cores and the external memory device. A typical cache hierarchy comprises a first-level cache (L1) closest to the processing core with lowest latency and smallest capacity, a second-level cache (L2) with intermediate latency and capacity, and a last-level cache (LLC, also referred to as L3) shared across multiple processing cores with the highest capacity and latency within the hierarchy. On a cache hit, data is served from the cache without accessing the external memory device. On a cache miss, the requested cache line is fetched from the next level of the hierarchy or from the external memory device and installed in the cache. When a cache line is displaced from a cache to accommodate a new cache line, an eviction occurs. The decision whether to write the evicted cache line back to the external memory device may depend, in conventional operation, on the modification state of the cache line.

A cache coherence protocol refers to a set of rules that ensures all processing cores and caches within the processor observe a consistent view of memory. For example, the MESI protocol, which may be the preferred cache coherence protocol for the purposes of various aspects described herein, defines four states for each cache line. A first state, modified, indicates the cache holds the only valid copy and the copy differs from the external memory device. A second state, exclusive, indicates the cache holds the only valid copy and the copy matches the external memory device. A third state, shared, indicates the cache line may be held simultaneously in multiple caches in a read-only form. A fourth state, invalid, indicates the cache does not hold a valid copy. State transitions may be coordinated through snoop operations, such as when one cache requests a cache line, the coherence protocol queries other caches to determine whether they hold a copy and, if so, in which state. Cache-to-cache transfers allow a cache holding a copy in a valid state to supply the data directly to the requesting cache.

A write-back, as described herein, refers to the operation of transferring a cache line from a cache within the processor's cache hierarchy to the external memory device. In conventional cache operation under the MESI protocol, a write-back is performed only for cache lines in the modified state, because only a modified cache line holds data that differs from the copy in the external memory device. Cache lines in the shared or exclusive states are considered clean, i.e., identical to the external memory device copy, and may be silently discarded upon eviction without generating any write traffic to the external memory device. In various aspects described herein, under read-once semantics, the external memory device invalidates its copy upon the first read, making the cached copy the sole valid copy regardless of the modification state of that cache line. The write-back operation is therefore mandatory for read-once designated cache lines irrespective of the MESI state.

Read-once semantics, as used herein, may refer to an access policy applied to a designated data unit under which the data may be read at most once from the external memory device. In an example, upon being read, the data is rendered unavailable for subsequent reads until new data is written to the same address. A read-once indicator may include a storage element within the memory device that, when in a set state, causes the control circuit of the memory device to apply read-once semantics to the associated data unit. In this state, the control circuit outputs the data and then renders the data unavailable. A read-once attribute may be a designation carried by a cache line within the processor's cache hierarchy that marks the cache line for special eviction handling. For example, when a cache line designated with the read-once attribute is evicted, the processor controller issues a write-back to the external memory device regardless of the modification state of the cache line. To emphasize, the read-once indicator may reside in the memory device. The read-once attribute may reside in the processor cache hierarchy. The two can be functionally related, such that the read-once indicator governs memory device behavior, while the read-once attribute governs processor cache management behavior.

A validity indicator, as used herein, may refer to any mechanism within the memory device by which the control circuit of the memory circuit records whether the data associated with a given data unit is in a valid state, meaning the data is available to be returned in response to a read operation, or an invalid state, meaning the data is not available to be returned. The control circuit of the memory device may implement the validity indicator through any physical mechanism that produces a reliably detectable distinction between the valid and invalid states. In one example, the validity indicator includes a dedicated storage element, such as a bit associated with each data unit, which may be maintained separately from the data itself within the memory device, for example within the ECC storage area or within a dedicated sideband storage structure. The control circuit of the memory device sets the dedicated storage element to a first state to indicate validity and to a second state to indicate invalidity. In another example, the control circuit of the memory device implements the validity indicator by clearing the storage cells of the memory array associated with the data unit upon rendering the data unit invalid, so that any subsequent read targeting that address returns a fixed pattern reflecting the cleared cell state rather than the previously written data. In other words, the cleared cell state may indicates the invalid state as the validity indicator. In a further example, the control circuit of the memory device implements the validity indicator by modifying the ECC bits associated with the stored data unit of the subject data, such that an ECC check performed upon a subsequent read detects an uncorrectable error, causing the control circuit of the memory device to suppress the return of the stored data. In other words, this modified ECC state may indicate the invalid state as the validity indicator. In each case, the validity indicator can govern the response of the control circuit of the memory device to read operations targeting the associated data unit, independently of the specific physical mechanism by which the valid or invalid condition is recorded within the memory device.. The memory device may include an interface configured to expose the validity indicator to an external device, for example by encoding the indicator in signals returned over the data bus or via a dedicated sideband signal, allowing the processor to detect an invalid condition before processing returned data.

A memory interposer, as used herein, refers to a physical device inserted between a processor or memory controller and a memory device on the memory bus, interposed in the signal path such that all signals exchanged between the processor and the memory device pass through the interposer. A memory interposer can observe all command, address, and data signals on the bus.

A memory controller may refer to a circuit configured to manage read and write operations to one or more memory devices. The memory controller may issue commands that direct memory devices to perform storage and retrieval operations, control the timing of data transfers, and process data received from memory devices during read operations. A memory device may be an integrated circuit including an array of storage cells that are accessible via a data interface. Memory devices retain data in addressable storage locations and transfer data to and from a memory controller in response to commands received over a command and address bus. A memory controller and one or more memory devices may communicate over a channel, which includes a set of signal connections, which may include data lines, strobe lines, clock lines, command and address lines, and chip select lines, through which the memory controller and the memory devices exchange data, commands, and timing signals. A memory subsystem may include one or more channels, each channel supporting one or more memory devices.

A memory array may refer to an arrangement of storage cells organized to accept write operations that store data and to return stored data in response to read operations. A memory array may be a structure within a memory device that has the physical capacity and interface to receive, retain, and return data in response to commands issued by a control circuit. For example, a memory array includes a plurality of memory banks, each memory bank including a plurality of rows and a plurality of columns of storage cells, with sense amplifiers coupled to the columns for reading and writing cell states. In an example, a memory array may be implemented as a dynamic random access memory array, in which storage cells comprise a capacitor and an access transistor and require periodic refresh to retain stored data, or as a static random access memory array, in which storage cells comprise a cross-coupled inverter pair that retains state without refresh. A memory array may alternatively be implemented using non-volatile storage cells. The memory array may be the passive storage component of the memory device, and the control circuit may be the active component that governs which storage cells are accessed, in what sequence, and subject to what access policies, including read-once semantics enforced upon data units stored within the memory array.

A read operation, as used herein, refers to a command issued to the memory device that causes the control circuit to retrieve data stored at a specified address within the memory array and output the retrieved data via the data interface of the memory device. A read operation targets data when the address carried by the read operation corresponds to the address at which that data is stored within the memory array, such that the control circuit selects the storage cells associated with that address as the source of the data to be output. The control circuit may determine, prior to outputting data in response to a read operation, the state of the read-once indicator and the validity indicator associated with the data unit at the targeted address. Illustratively, a read operation may be issued by a processor memory controller, a direct memory access controller, or any other entity coupled to the memory device via the memory interface.

Various aspects described herein may include a memory device including a memory array configured to store data and a control circuit coupled to the memory array. The control circuit may be configured to, in response to a read operation targeting data for which a read-once indicator associated with the data stored in the memory array is set, output the data and render the data unavailable for a subsequent read operation. For example, the rendering unavailable action can be affected by the control circuit setting a validity indicator associated with the data to a state indicating that the data is invalid. In another example, the rendering unavailable action includes clearing corresponding storage cells of the memory array associated with that data unit, so that any subsequent read returns a fixed pattern reflecting the cleared cell state rather than the previously written data. In a further example, the rendering unavailable action includes modifying the ECC bits associated with the stored data such that the ECC check performed on a subsequent read detects an uncorrectable error, causing the memory device to suppress the return of the stored data. The validity indicator may be associated with the data stored in the memory array at a predetermined granularity, such that the control circuit can determine, for any read operation targeting a specific data unit, whether the validity indicator for that data unit indicates a valid or invalid state prior to outputting data. A data unit for which the validity indicator is set to the invalid state cannot be read again until new data is written to the address of that data unit, at which point the control circuit sets the validity indicator to the valid state. This behavior can ensure that each data unit designated with the read-once indicator is available for at most one read operation from the memory device before the memory device transitions that data unit to an unreadable state.

In various aspects described herein, a processor comprises a cache hierarchy comprising at least one cache, a memory interface configured to communicate with an external memory device that is external to the processor, and a controller coupled to the cache hierarchy and the memory interface. The controller may be configured to, upon eviction of a cache line designated with a read-once attribute from the cache hierarchy, issue a write-back of the cache line to the external memory device via the memory interface. The controller may issue the write-back regardless of the modification state of the cache line. In conventional cache operation, a cache line that has not been modified since being fetched from the external memory device may be silently discarded upon eviction, on the basis that the external memory device retains an identical copy. Under read-once semantics described herein, the external memory device has rendered its copy invalid upon the initial read, making the cache line the sole valid copy of the data. The controller therefore issues a write-back upon eviction of any cache line designated with the read-once attribute, whether the cache line is in a modified, exclusive, or shared state, to ensure that valid data is returned to the external memory device before the cache line is removed from the cache hierarchy.

In various aspects described herein, a computing system comprises the memory device and the processor described above can operate in combination. The combined operation can enforce a mutual exclusion invariant, such that data designated as read-once is valid in at most one of the cache hierarchy or the memory device at any given time. When the memory device outputs read-once data in response to a read operation, the memory device may set the validity indicator to invalid, so that the memory device no longer holds a valid copy. The processor can hold the sole valid copy within the cache hierarchy with the read-once attribute set. When all cached copies are evicted, the controller may issue a write-back carrying an indication that the data is to be designated as read-once, and the memory device stores the data, sets the read-once indicator, and sets the validity indicator to valid, so that the memory device again holds the sole valid copy. In this combined operation, the processor and the memory device are configured such that at no point in this lifecycle is the data valid simultaneously in both the cache hierarchy and the memory device. The control circuit may set the read-once indicator in response to receiving a write operation comprising an indication that the data is to be designated as read-once, so that the read-once designation is communicated explicitly through the write operation and re-established each time the data is written back.

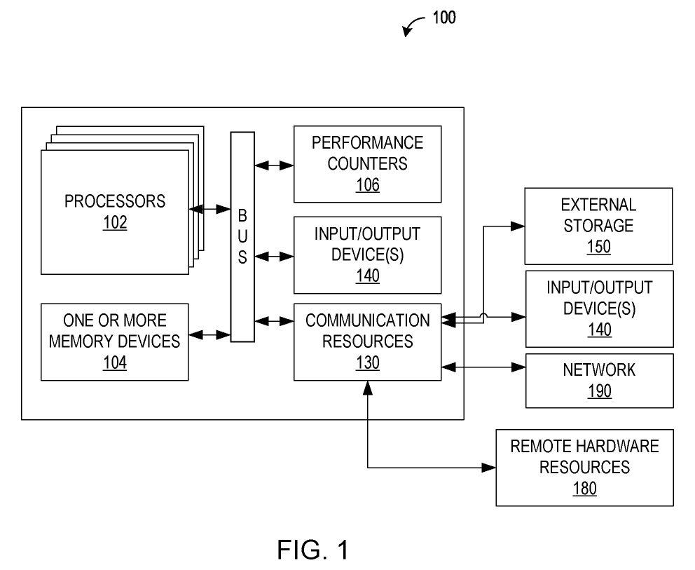

FIG. 1 illustrates a block diagram of an example computing system 100 in accordance with various aspects described herein. The computing system 100 typically includes a system of interconnected hardware and software resources configured to execute instructions, process data, and manage the allocation of computational capabilities. The computing system 100 may be a server, a workstation, a cluster of servers, a data center, a mobile computing platform, a client computing device, or a cloud computing infrastructure. External storage 150, network 190, external input and output devices 140, and remote hardware resources 180 connect to the hardware resources via the communication resources 130 and input and output devices 140.

The computing system 100 generally includes one or more processors (102), one or more memory devices 104, a bus, the communication resources 130, and the one or more input/output devices 140. The processors 102 represent the computational core of the computing system 100, and each processor among the processors 102 may integrate a cache hierarchy and a memory controller through which the processor 102 initiates memory transactions directed to the one or more memory devices 104. The memory controller includes a physical interface layer that includes the signal connections between the processors 102 and the one or more memory devices 104. The physical interface layer may further facilitate timing relationships and implement data transfer protocols through which the processors 102 communicate with the one or more memory devices 104. The physical interface layer may carry sideband signals between the memory controller and the one or more memory devices 104, including error signals and status indicators exchanged between the memory controller and the memory devices 104. The capacity of the memory subsystem accessible through this interface may be based in part on the number and configuration of memory devices 104 coupled to the interface.

The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a digital signal processor (DSP), an application-specific integrated circuit (ASIC), a field-programmable gate array (FPGA), a microprocessor or controller, a multi-core processor, a multithreaded processor, an ultra-low voltage processor, an embedded processor, a data processing unit (DPU), an infrastructure processing unit (IPU), a network processing unit (NPU), or any suitable combination thereof.

Each processor among the processors 102 communicates with the one or more memory devices 104 through a memory controller that manages command scheduling, address mapping, rank selection, and coordination of data transfers, incorporating timing control logic that enforces the temporal constraints imposed by the memory interface specification. The memory controller issues commands to open memory rows within specified memory banks for read and write operations. The memory controller may include logic for managing the status of data stored in the one or more memory devices 104, including tracking which data units require special handling upon cache eviction. The memory controller may include a data interface having a designated data width and a read data strobe input through which the memory controller receives timing reference signals from the one or more memory devices 104, using those timing reference signals to determine the correct sampling instants for data received on the data interface.

In some examples, the one or more processors 102 may execute instructions. Instructions may include software, program code, applications, firmware, microcode, machine code, or other executable code for causing at least any one of the processors 102 to perform a method. The instructions may reside, completely or partially, within at least one of the processors 102, the memory devices 104, or any suitable combination thereof. Furthermore, any portion of the instructions may be transferred to the computing system 100 from any combination of the input and output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. Each memory device 104 may include internal control circuitry for enforcing access policies on stored data units. Each memory device 104 may store per-data-unit metadata comprising status indicators that govern the response of the memory device 104 to read and write requests targeting those data units, in addition to the data itself. In some configurations, the one or more memory devices 104 are coupled to the memory controller of the processors 102 over one or more memory channels, with each memory channel including a set of data lines, a write clock line, a command and address bus, one or more chip select lines, and a read data strobe line.

As examples, the memory devices 104 can be or can include random access memory (RAM), static RAM (SRAM), dynamic RAM (DRAM), synchronous DRAM (SDRAM), dual inline memory modules (DIMMs), microDIMMs, MiniDIMMs, or other volatile memory devices. The one or more memory devices 104 may conform to memory interface specifications including DDR5, LPDDR6, DDR6, HBM5, GDDR7, or other current or future memory specifications. Each memory device 104 may be packaged individually or in a vertically stacked arrangement within a common package, and may include one or more independently addressable ranks accessible via respective chip select signals.

The processors 102 and the one or more memory devices 104 communicate via a bus or an interconnect system. The bus represented in FIG. 1 generally illustrates the data pathways within the computing system 100. The memory interface between the memory controller and each memory device 104 carries multiple physical signal groups: unidirectional command and address signals on the command and address bus, chip select signals, a differential system clock, and bidirectional data signals that carry read and write data between the memory controller and the memory devices 104. The command and address bus may carry commands with extended encodings that include access type designations communicated alongside data transfer commands, enabling the memory controller to convey memory access properties to the memory devices 104 as part of the command stream.

The communication resources 130 enable the computing system 100 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. The communication resources 130 connect the computing system 100 to the network 190. The network 190 may be a local area network, a wide area network, the internet, or a dedicated storage area network. Through the network 190, the computing system 100 may access the remote hardware resources 180 and the external storage 150.

The computing system 100 may include multiple memory channels, each with its own independent command and address bus, data bus, and sideband signal path. Each memory channel connects to one or more memory devices 104 and is independently controlled by the memory controller. Within each channel, memory may be organized into one or more ranks, where each rank includes a set of memory devices 104 accessed in parallel in response to a single command, and into subchannels representing independent data paths within the channel. The memory controller manages commands across all ranks and subchannels within each channel. Performance counters (106) accessible via the bus may be used to monitor memory access patterns across the memory channels of the computing system 100.

The input/output devices 140 associated with the computing system 100 represent local peripheral interfaces and devices. The input/output devices 140 may include storage controllers, universal serial bus controllers, and interfaces for human interaction devices. The input/output devices 140 may also include hardware accelerators, such as field-programmable gate arrays or application-specific integrated circuits, installed to offload specific processing tasks from the processors 102. These peripheral components generate memory traffic that flows through the memory controller of the processors 102.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system, the computing system 100 may function as one physical node in a larger cluster, with the remote hardware resources 180 constituting the other physical nodes. The remote hardware resources 180 may possess similar or different configurations compared to the computing system 100. The ability of the computing system 100 to communicate with the remote hardware resources 180 enables distributed processing, where a single large task is decomposed into smaller sub-tasks executed in parallel across multiple machines.

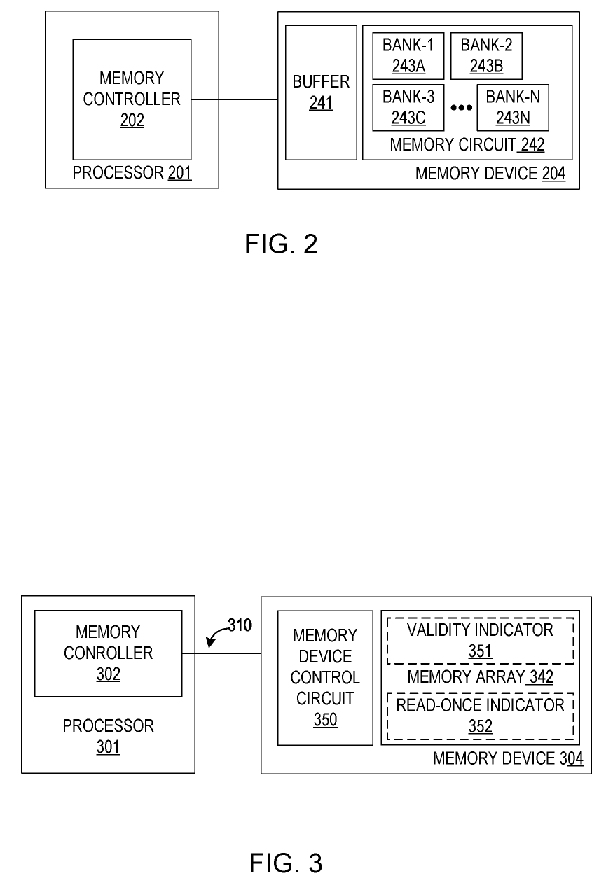

The computing system 100 described with reference to FIG. 1 provides the environment in which the memory system described in further detail with reference to FIGS. 2 and 3 operates. The memory controller and the one or more memory devices 104, together with the command and data interfaces connecting them, form the memory system within which the memory freshness enforcement techniques described herein may be implemented

FIG. 2 illustrates a block diagram of an example system including a processor 201 and a memory device 204. In an example, the example system is a part of a computing system (e.g., the computing system 100). The processor 201 comprises a memory controller 202 that is configured to manage the issuance of commands and the scheduling of data transfers to and from the memory device 204. The memory device 204 may include a buffer 241 coupled to the memory controller 202 via the memory bus. The memory device 204 includes a memory circuit 242 that may be coupled to the buffer 241. The memory circuit 242 comprises a plurality of memory banks, including a first bank (243A), a second bank (243B), a third bank (243C), and an N-th bank (243N), organized as an array of addressable storage cells.

The memory controller 202 may reside within the processor 201 and translate memory access requests originating from the cache hierarchy of the processor 201 into commands conforming to the protocol of the memory bus. The memory controller 202 may comprise a command scheduler that determines the order in which commands are issued to the memory device 204, an address decoder that maps physical memory addresses to specific banks, rows, and columns within the memory circuit 242, and a data buffer that stages write data prior to transmission and read data upon reception. The memory controller 202 communicates with the memory device 204 over an interface (e.g., a memory bus). The interface may carry a command and address bus, a bidirectional data bus, a differential system clock, and one or more chip select signals. In conventional operation, the memory controller 202 issues a write command when a modified cache line is evicted from the cache hierarchy, and issues a read command when a cache miss occurs and the requested cache line must be fetched from the memory device 204.

The buffer 241 within the memory device 204 may receive commands and data from the memory controller 202 and presents them to the memory circuit 242 in a form suitable for internal operation. For example, the buffer 241 comprises a command decoder that interprets commands received on the command and address bus and a data interface that drives and receives data on the data bus in coordination with the system clock. The buffer 241 may manage the timing of internal operations initiated in response to received commands, including row activation, data read, data write, and precharge sequences within the memory circuit 242. The buffer 241 may be the boundary between the external memory bus and the internal organization of the memory device 204, such that all commands and data exchanged between the memory controller 202 and the memory circuit 242 pass through the buffer 241.

The memory circuit 242 may be organized into the plurality of memory banks 243A through 243N. Each memory bank among the memory banks 243A through 243N may include a two-dimensional array of storage cells arranged in rows and columns, with a row of storage cells constituting the unit of activation within the memory bank. Each memory bank 243A through 243N further may include a row of sense amplifiers coupled to the columns of the storage cell array. The sense amplifiers can detect and amplify the small voltage differentials developed on the column bit lines when a row is activated, and drive the amplified values back into the storage cells during a write operation. Each memory bank 243A through 243N may operate independently, permitting the memory controller 202 to pipeline commands across multiple banks to improve overall memory bandwidth utilization. The memory circuit 242 may constitute the memory array of the memory device 204, such that the memory circuit 242 is the structure within the memory device 204 that accepts write operations, retains stored data, and returns stored data on read operations at a granularity corresponding to the cache line size.

A read operation targeting a specific cache line may proceed as follows in conventional operation. The memory controller 202 issues an activation command carrying the row address associated with the target cache line to the buffer 241, which forwards the activation command to the appropriate memory bank among the memory banks 243A through 243N. The activated row's storage cells are connected to the sense amplifiers, which latch the stored data values. The memory controller 202 subsequently issues a read command carrying the column address of the target cache line. The buffer 241 forwards the read command to the activated bank, and the sense amplifiers drive the data onto the internal data path, from which the buffer 241 serializes and transmits the data to the memory controller 202 over the data bus. The memory controller 202 receives the data and places the cache line in the cache hierarchy. In conventional operation, the read operation does not alter any state within the memory device 204 beyond the temporary activation of the addressed row; the data remains available for subsequent reads without restriction.

A write operation targeting a specific cache line may proceed as follows in conventional operation. The memory controller 202 issues an activation command to open the target row within the appropriate memory bank, followed by a write command carrying the column address and accompanied by the write data driven onto the data bus. The buffer 241 receives the write command and data and forwards both to the activated bank, where the sense amplifiers write the data values into the storage cells at the addressed columns. The memory controller 202 subsequently issues a precharge command to close the activated row. In conventional operation, the write operation stores the new data and overwrites whatever was previously stored at the addressed location. The memory device 204 provides no mechanism by which the successful commitment of a write operation can be verified by the issuing memory controller 202; the memory controller 202 proceeds on the assumption that the write was committed upon issuing the command.

The memory device 204 may include storage for metadata associated with data units in the memory circuit 242. In implementations supporting error correction, a portion of the storage capacity of each memory bank may be allocated to ECC data computed over each cache line. The ECC storage area may additionally carry security attributes associated with the data, such as a TEE Owner bit identifying the trusted execution environment instance that wrote the data, stored alongside the ECC data at the granularity of a cache line. The per-cache-line storage available in the ECC area, and the ability of the buffer 241 to access and update that storage independently of the data array, can form the physical basis for the per-data-unit indicators described in connection with various other aspects described herein.

The interaction between the memory controller 202 and the cache hierarchy of the processor 201 in conventional operation may be governed by the modification state of cache lines. When a cache line in the modified state is evicted from the cache hierarchy, the memory controller 202 may issue a write command to the memory device 204 carrying the cache line data. When a cache line in the shared or exclusive state is evicted, the memory controller 202 does not issue any write command to the memory device 204, because the memory device 204 is considered to hold an identical copy. This behavior, involving eviction of a clean cache line without a corresponding write to the memory device 204, may be referred to herein as a silent discard. The silent discard of a clean cache line does not cause data loss under conventional operation, because the memory device 204 retains a valid copy.

The combination of the conventional read behavior of the memory device 204, involving returning data without altering internal state, and the silent discard of clean cache lines by the memory controller 202 may define the vulnerability that are addressed in various aspects described herein. In various aspects described herein, after the memory device 204 returns read-once data in response to a read operation and invalidates its copy, the only remaining valid copy resides in the cache hierarchy of the processor 201. If the memory controller 202 subsequently evicts that cache line without issuing a write-back, no valid copy of the data exists anywhere in the system. Conversely, if a memory interposer drops a write-back directed at the memory device 204, the memory device 204 retains whatever state it held prior to the write, in the case of read-once data, the invalid state.

FIG. 3 illustrates an example block diagram of a system. The system includes a processor 301 and a memory device 304. In an example, the system depicted here is a part of a computing system (e.g., the computing system 100). The system depicted here may correspond to the system described in accordance with FIG. 2 in a configuration, such that the system of FIG. 3 may be configured to implement read-once semantics described herein.

The processor 301 comprises a memory controller 302. The processor 301 may further include a memory interface 310, through which the processor 301 communicates with the memory device 304. The memory device 304 comprises a memory device control circuit 350, a memory array 342. The memory device 304 may further include a validity indicator 351 associated with data stored in the memory array 342, and a read-once indicator 352 associated with data stored in the memory array 342. The memory device control circuit 350 may be coupled to the memory array 342 and may govern the behavior of the memory device 304 in response to read and write operations received via the memory interface 310. The memory array 342, the validity indicator 351, and the read-once indicator 352 are each depicted within the memory device 304, indicating that all three may reside within the memory device 304 and are accessible to the memory device control circuit 350.

The memory array 342 of the memory device 304 may be any arrangement of storage cells within the memory device 304 that is organized to accept write operations storing data and to return stored data in response to read operations. For example, the memory array 342 comprises a plurality of memory banks each organized as a two-dimensional array of storage cells arranged in rows and columns. The memory array 342 may further include sense amplifiers coupled to the columns for reading cell states and writing data into cells. The memory array 342 may be implemented as a dynamic random access memory array in which each storage cell comprises a capacitor and an access transistor, as a static random access memory array in which each storage cell comprises a cross-coupled inverter pair, or as an array of non-volatile storage cells. The memory array 342 is the passive storage component of the memory device 304; the memory device control circuit 350 may be the active component. The memory device control circuit 350 may determine which storage cells are accessed and what access policies apply to the data stored therein, including the read-once semantics enforced through the read-once indicator 352 and the validity indicator 351.

The memory device control circuit 350 may be any logic circuitry within the memory device 304 that is configured to govern the response of the memory device 304 to incoming commands received via the memory interface 310. In an example, the memory device control circuit 350 comprises a command decoder and an associated state machine that interprets commands from the command and address bus. The state machine may further orchestrate internal operations including row activation, sense amplifier read and write, and precharge within the memory array 342. In an example, the memory device control circuit 350 may be implemented as dedicated digital logic on the memory device die, as a microcontroller embedded within the memory device 304, or as a combination of combinational and sequential logic circuits. The memory device control circuit 350 has read and write access to both the data stored in the memory array 342 and the associated per-data-unit metadata comprising the read-once indicator 352 and the validity indicator 351.

The read-once indicator 352 may be any state element within the memory device 304 that, when in a set state, causes the memory device control circuit 350 to apply read-once semantics to the data unit associated with that indicator. For example, the read-once indicator 352 comprises a single bit stored in association with each data unit in the memory device 304, such as each cache line of 64 bytes, where a set state of that bit indicates that the associated data unit is subject to single-read enforcement. The read-once indicator 352 may be associated with data stored in the memory array 342 by a defined correspondence. For example, for any read operation targeting a specific address, the memory device control circuit 350 can determine whether the read-once indicator 352 for the data unit at that address is set.

In an example, the read-once indicator 352 may be stored within the ECC area of the memory array 342 alongside the data, within a dedicated sideband storage array within the memory device 304, or within a register file accessible to the memory device control circuit 350. The association between the read-once indicator 352 and the data may be by address mapping, such that each address range maps to a specific indicator, or by co-location, such that the indicator is stored physically adjacent to the corresponding data.

When the memory device control circuit 350 receives a read operation targeting a data unit for which the read-once indicator 352 is set, the memory device control circuit 350 may perform two actions. First, the memory device control circuit 350 may output the data stored in the memory array 342 at the targeted address via the memory interface 310. Second, the memory device control circuit 350 may render the data unavailable for a subsequent read operation by modifying the internal state of the memory device 304. In one specific example, these two actions are performed atomically, i.e., as a single indivisible operation, with respect to the read operation, such that the data is provided to the requester and the internal state is updated such that any subsequent read targeting the same address will not return the original data. The memory device control circuit 350 may render the data unavailable after its single (i.e., the first) output. In an example, the memory device control circuit 350 renders the data unavailable by setting the validity indicator 351 associated with the targeted data unit to a state indicating that the data is invalid. In one example, setting the validity indicator 351 to a state indicating that the data is invalid includes setting a dedicated storage element corresponding to the validity indicator 351 to a first state indicating invalidity. In another example, setting the validity indicator 351 to a state indicating that the data is invalid includes clearing the storage cells of the memory array associated with the data unit upon rendering the data unit invalid, as described herein. In a further example, setting the validity indicator 351 to a state indicating that the data is invalid includes modifying the ECC bits associated with the stored data unit of the subject data, such that an ECC check performed upon a subsequent read detects an uncorrectable error, causing the control circuit of the memory device to suppress the return of the stored data. From this point, the data unit is in the invalid state. In the invalid state, the memory device 304 is configured to not to output the stored data in response to a subsequent read targeting that address, for example until new data is written to that address.

The memory device 304 may operate as a self-contained unit with respect to the enforcement of read-once semantics. The memory device control circuit 350 can autonomously enforce the single-read property once the read-once indicator 352 is set, without requiring instructions or cooperation from the processor 301 at the time of enforcement. The memory device 304 may be configured not to distinguish between read operations issued by the processor 301, a direct memory access controller, or any other entity coupled via the memory interface 310. In an example, the enforcement is applied based solely on the state of the read-once indicator 352 associated with the targeted data unit. While the memory device 304 operates autonomously in this respect, the read-once behavior of the memory device 304 may be designed to cooperate with a processor 301 that adapts its cache management accordingly. Specifically, the invalidation performed by the memory device control circuit 350 upon a read creates the requirement that the processor 301 issue a write-back of any read-once cache line upon eviction from the cache hierarchy, which may be the behavior implemented by the memory controller 302 as described herein.

The processor 301 comprises the cache hierarchy, which is a multi-level structure of cache memories internal to the processor 301 through which data passes between processing cores and the memory device 304 via the memory interface 310. The memory interface 310 may be the physical and logical boundary through which the processor 301 exchanges commands and data with the memory device 304. In an example, the memory interface 310 encompasses both the physical signal connections on the memory bus and the protocol logic within the memory controller 302 for issuing read and write commands. The memory device 304 is external to the processor 301, meaning the memory device 304 resides outside the processor die or package and is coupled to the processor 301 via the memory interface 310. The memory interface 310 may be implemented as a DDR5 physical interface, an LPDDR interface, or an HBM interface, among others. The memory controller 302 is coupled to the cache hierarchy and to the memory interface 310, giving the memory controller 302 visibility into cache line states and eviction events within the cache hierarchy and the ability to issue read and write commands to the memory device 304.

The memory controller 302 may be any logic within the processor 301 that is configured to manage data movement between the cache hierarchy and the memory device 304 via the memory interface 310. For example, the memory controller 302, as described herein, can include cache management logic and memory controller logic that jointly determine when and how cache lines are fetched from or written back to the memory device 304 and that enforce eviction policies including the mandatory write-back policy for cache lines designated with the read-once attribute. The memory controller 302 may be implemented as a unified cache and memory controller block, or as separate but interconnected cache controller and memory controller units that jointly implement corresponding aspects described herein. The memory controller 302 may have visibility into the modification state of each cache line in the cache hierarchy and can observe eviction events, check per-cache-line attributes, and initiate snoop operations directed to caches within the cache hierarchy.

Upon eviction of a cache line designated with the read-once attribute from the cache hierarchy, the memory controller 302 issues a write-back of that cache line to the memory device 304 via the memory interface 310. An eviction occurs when a cache line is removed from a cache within the cache hierarchy. In an example, an eviction may be triggered by capacity constraints requiring that space be made for a new cache line In an example, an eviction may be triggered by explicit invalidation, or by cache coherence protocol actions.

The memory controller 302 may be configured to issue the write-back regardless of the modification state of the cache line. That is to say, whether the cache line is in the modified, exclusive, or shared state, the memory controller 302 generates a write command through the memory interface 310 carrying the cache line data directed to the address in the memory device 304 from which the data was originally read. Because the memory device control circuit 350 has invalidated its copy of the data upon the initial read, making the cache line in the cache hierarchy the sole valid copy, discarding that cache line without a write-back would result in the permanent loss of the data.

The read-once attribute may be a designation carried by cache lines in the cache hierarchy of the processor 301 that marks those cache lines for the mandatory write-back handling described above. A cache line may acquire the read-once attribute when the memory controller 302 fetches data from the memory device 304 and determines that the data has read-once semantics, either through a sideband signal received from the memory device 304, through metadata associated with the returned data, or through an address range check against a configured read-once memory region. The memory controller 302 may store the read-once attribute as a bit associated with each cache line in the cache hierarchy, so that the attribute travels with the cache line as it moves between cache levels.

In conventional cache operation, a clean cache line can be evicted without generating memory bus traffic because the memory device 304 is assumed to hold an identical copy. Under read-once semantics this assumption does not hold, because the memory device control circuit 350 has invalidated the memory device's copy upon the initial read. The mandatory write-back policy implemented by the memory controller 302 addresses this by ensuring that the memory device 304 receives the data before the cache line is removed from the cache hierarchy.

To illustrate the interoperation of the processor 301 and the memory device 304, consider first a single-core processor with a single cache level. The memory controller 302 fetches a cache line designated as read-once from the memory device 304. Then, the memory device control circuit 350 outputs the data and sets the validity indicator 351 to invalid and the memory controller 302 places the cache line in the cache with the read-once attribute set. When the cache line is subsequently evicted, the memory controller 302 issues a write-back to the memory device 304. The memory device control circuit 350 stores the new data, sets the validity indicator 351 to valid, and sets the read-once indicator 352. As a second example, in a multi-core processor where two cores hold copies of a read-once cache line in the shared state, no write-back is issued while at least one copy remains in the cache hierarchy. When the last remaining copy is evicted, the memory controller 302 issues the write-back. The mandatory write-back by the processor 301 may complement to the invalidation-on-read by the memory device 304. Illustratively, without the write-back, the memory device 304 could permanently lose valid data after a read; without the invalidation, the memory device 304 could retain potentially stale data that could be consumed after a dropped write.

In one example, setting the validity indicator 351 to a state indicating that the data is valid includes setting a dedicated storage element corresponding to the validity indicator 351 to a second state indicating validity. In another example, setting the validity indicator 351 to a state indicating that the data is invalid includes writing the data to assigned the storage cells of the memory array, which the data is different from cleared states of the storage cells. In a further example, setting the validity indicator 351 to a state indicating that the data is valid includes setting the ECC bits associated with the stored data, such that an ECC check performed upon a subsequent read does not detect an uncorrectable error.

A lifecycle of a read-once data unit through the system of FIG. 3 may proceed as follows. In a first step, the memory controller 302 issues a write operation to the memory device 304 with an indication that the data is to be designated as read-once. The memory device control circuit 350 stores the data in the memory array 342, sets the read-once indicator 352, and sets the validity indicator 351 to valid, so that the memory device 304 holds the sole valid copy. In a second step, the memory controller 302 issues a read operation; the memory device control circuit 350 returns the data via the memory interface 310 and sets the validity indicator 351 to invalid, so that the memory device 304 no longer holds a valid copy. The memory controller 302 places the cache line in the cache hierarchy with the read-once attribute set, so that the cache hierarchy holds the sole valid copy. In a third step, processing cores may use the data, and the cache line may be held in one or more caches within the cache hierarchy in the shared state. In a fourth step, all cached copies are evicted, and the memory controller 302 issues a write-back to the memory device 304 with an indication of read-once semantics. The memory device control circuit 350 stores the data, sets the read-once indicator 352, and sets the validity indicator 351 to valid, completing one cycle. This lifecycle demonstrates an example in which at every point in this lifecycle, exactly one location, either the cache hierarchy or the memory device 304, holds a valid copy of the data.

If an attacker drops the write-back in the fourth step of the lifecycle described above, the memory device 304 retains its invalid state from the second step, in which the validity indicator 351 was set to invalid upon the initial read. Any subsequent read operation issued by the memory controller 302 to the memory device 304 targeting that address may receive an error signal or a predetermined data pattern in response, rather than stale data, because the validity indicator 351 indicates invalid. If an attacker drops the initial write in the first step, the memory device 304 does not hold valid data at the targeted address at all, and any subsequent read will similarly fail. The combination proposed by the system of FIG. 3 facilitates a guarantee that stale, valid data cannot persist in the memory array 342 after it has been read and the subsequent write-back has been dropped.

In an example, data stored in the memory array 342 is organized in data units of a predetermined granularity, and a respective read-once indicator 352 is associated with each data unit. In an example, each data unit may be a cache line of 64 bytes, matching the granularity at which the processor 301 transfers data to and from the memory device 304 via the memory interface 310. Correspondingly, the memory controller 302 may store the read-once attribute as a bit associated with each cache line in the cache hierarchy, so that the per-data-unit granularity of the read-once indicator 352 in the memory device 304 and the per-cache-line granularity of the read-once attribute in the cache hierarchy are aligned. This alignment can ensure that the read-once semantics are consistently applied when data moves between the memory device 304 and the cache hierarchy. For example, each cache line fetched from a read-once data unit in the memory array 342 carries the read-once attribute within the cache hierarchy, and each write-back of that cache line causes the memory device control circuit 350 to set the read-once indicator 352 for the corresponding data unit in the memory array 342.

In an example, the read-once indicator 352 is stored within the memory device 304 as a bit, and the read-once indicator 352 is not externally accessible. The memory device control circuit 350 and the read-once indicator 352 may be configured, such that the read-once indicator 352 cannot be directly read or modified by the memory controller 302 or any other entity external to the memory device 304. For example, the read-once indicator 352 is configured to be set or cleared only by the memory device control circuit 350 in response to write operations as described herein.

In an example, the memory device 304 further comprises the validity indicator 351 associated with data stored in the memory array 342, and the memory device control circuit 350 is configured to render the data unavailable for a subsequent read operation by setting the validity indicator 351 to a state indicating that the data is invalid. The validity indicator 351 may be stored as a dedicated bit per data unit within the ECC storage area of the memory array 342 alongside the corresponding data, within a dedicated sideband storage structure within the memory device 304, or within a register file accessible to the memory device control circuit 350. The validity indicator 351 has a valid state indicating that the associated data unit may be returned in response to a read operation, and an invalid state indicating that the associated data unit may not be returned. The memory device control circuit 350 may be configured to transition the validity indicator 351 from the valid state to the invalid state atomically with returning the data in response to a read operation targeting a data unit for which the read-once indicator 352 is set. The memory device 304 may further comprise an interface configured to expose the validity indicator 351 to an external device. For example, the memory device 304 (i.e., the memory device control circuit 350) may encode the state of the validity indicator 351 in signals returned over the data bus, by asserting a dedicated sideband signal, or by encoding the indicator analogously to poison bits in existing memory interface specifications, so that the memory controller 302 can detect an invalid condition upon receiving a response from the memory device 304.

In an example, in response to a write operation targeting a data unit for which the validity indicator 351 indicates that the data is invalid, the memory device control circuit 350 may set the validity indicator 351 to indicate that the data is valid. A write operation directed to an address at which the validity indicator 351 is in the invalid state may cause the memory device control circuit 350 to store the new data in the memory array 342 and transition the associated validity indicator 351 to the valid state, restoring the readability of that data unit. Correspondingly, when the memory controller 302 issues a write-back of a cache line designated with the read-once attribute, the memory controller 302 issues the write-back regardless of the modification state of the cache line. The memory controller 302 may be configured to issue the write-back whether the cache line is in the modified, exclusive, or shared state, because the memory device 304 holds an invalid copy regardless of the modification state of the cached copy, and a write-back is required to restore valid data to the memory device 304.

In an example, in response to a read operation targeting a data unit for which the validity indicator 351 indicates that the data is invalid, the memory device control circuit 350 outputs an error signal to the entity that issued the read operation. The error signal may be asserted on a dedicated signal line of the memory interface 310 or encoded within the data returned on the data bus, indicating to the memory controller 302 that the read operation did not return valid stored data. In another example, in response to a read operation targeting a data unit for which the validity indicator 351 indicates that the data is invalid, the memory device control circuit 350 outputs a predetermined data pattern to the entity that issued the read operation. The predetermined data pattern may be an all-zeros pattern.

Correspondingly, the memory controller 302 may receive an unambiguous indication that valid data is not available at the targeted address. When the memory controller 302 receives an error signal or a predetermined data pattern in response to a read targeting a read-once data unit, this response indicates that the validity indicator 351 was in the invalid state, which in a system operating without interference should not occur if the mandatory write-back policy has been correctly maintained. Accordingly, receipt of such a response constitutes a strong indicator that the write-back was dropped by an intervening device. In an example, in response to each and every read operation targeting a data unit for which the validity indicator 351 indicates that the data is invalid, the memory device control circuit 350 outputs an error signal to the entity that issued the read operation.

In an example, the memory device control circuit 350 is configured to service a data request targeting a cache line for which the read-once attribute is set from the cache hierarchy without issuing a read request to the memory device 304 via the memory interface 310, when at least one copy of the cache line is held in the cache hierarchy. Once the memory device control circuit 350 has invalidated the validity indicator 351 upon an initial read, the memory device 304 cannot supply a valid copy of the data in response to a subsequent read. Therefore, if a processing core or another cache within the processor 301 requires the data while at least one copy remains in the cache hierarchy, the memory controller 302 is required to obtain the data from within the cache hierarchy rather than issuing a new read to the memory device 304. The memory controller 302 may initiate a snoop operation directed to caches within the cache hierarchy. A snoop operation includes a query sent by the memory controller 302 to caches within the cache hierarchy to determine whether those caches hold a copy of the requested cache line. If a cache responds positively to the snoop, the data is obtained via a cache-to-cache transfer in which the holding cache supplies the data directly to the requesting cache, bypassing the memory interface 310 entirely. For read-once cache lines, the cache-to-cache transfer may be the required mechanism for supplying the data, because the memory device 304 cannot serve the data while the validity indicator 351 is in the invalid state.

In an example, the memory controller 302 is configured to operate the cache hierarchy according to a cache coherence protocol, preferably a MESI protocol. The cache coherence protocol permits a cache line designated with the read-once attribute to be held in the shared state across a plurality of caches within the cache hierarchy simultaneously. Unlike a conventional shared-state cache line, which may be silently discarded by any cache without generating write traffic, a shared-state cache line designated with the read-once attribute requires that the memory controller 302 issue a write-back when the last remaining copy of the cache line is evicted from the plurality of caches. The memory controller 302 may therefore be configured to track whether a given eviction of a shared-state read-once cache line is the eviction of the last remaining copy. Furthermore, the memory controller may be configured to, only upon eviction of the last remaining copy, issue the write-back to the memory device 304.

In an example, the memory controller 302 is configured to designate one copy of a read-once cache line held in the shared state as a primary copy. The cache holding the primary copy may be configured for two functions. The cache may be configured to respond to snoop requests directed to that cache line from other caches or processing cores within the cache hierarchy, and the cache may be configured to issue the write-back to the memory device 304 upon eviction of the primary copy. The designation of a primary copy can facilitate that there is at all times exactly one cache responsible for write-back, preventing a scenario in which all caches holding copies in the shared state discard those copies without any cache issuing a write-back.

In an example, upon eviction of the primary copy from a cache while at least one other copy of the cache line remains in the shared state within the cache hierarchy, the memory controller 302 transfers the primary copy designation to another cache holding a copy of the cache line. The transfer of the primary copy designation ensures continuity of write-back responsibility, such that at any point at which a copy of the read-once cache line remains in the cache hierarchy, exactly one cache holds the primary copy designation and is responsible for issuing the write-back upon its eviction. This mechanism may be applicable to multi-socket systems in which copies of a read-once cache line may be distributed across caches on different processor sockets, and in which the primary copy designation may transfer between sockets.

In an example, the memory controller 302 is configured to designate the read-once attribute for cache lines corresponding to a region of a memory address space based on a memory type assigned to the region. A memory type may correspond to a classification defined for a region of the physical address space that governs how the processor 301 handles data fetched from that region, similar to memory types such as write-back, write-through, and uncacheable defined at the instruction set architecture level. A read-once memory type may be defined at the instruction set architecture level, so that the processor 301 automatically applies the read-once attribute to any cache line fetched from an address falling within a region designated with the read-once memory type. When the memory controller 302 fetches a cache line from an address within a read-once region, the memory controller 302 sets the read-once attribute on the resulting cache line in the cache hierarchy.

In an example, the processor 301 further comprises a range register configured to define a region (e.g., a contiguous region) of the memory address space as having the memory type corresponding to the read-once attribute. The range register may specify a base address and a size, or a base address and a limit address, that together define the boundaries of the read-once region in the memory. The memory controller 302 may check the address of each memory access against the range register to determine whether the read-once attribute applies to the resulting cache line. A plurality of range registers may be provided within the processor 301 to permit the definition of multiple non-contiguous read-once regions within the memory address space. Range registers for memory type assignment are established mechanisms at the instruction set architecture level, and the read-once memory type may be defined and assigned through the same register-based interface, so that the read-once memory type is a first-class memory type alongside existing memory types.

In an example, the processor 301 further comprises an interface configured to allow a trusted execution environment module to assign the memory type corresponding to the read-once attribute to a region of the memory address space. The trusted execution environment module is preferably a trust domain extensions module. The trust domain extensions module may assign the read-once memory type to regions of memory associated with its own operation, and may expose an application binary interface to trust domain instances running within the trusted execution environment to allow those instances to request that memory allocated to them be designated with the read-once memory type. This interface provides a software-controlled and dynamically configurable path for assigning read-once protection to memory regions, complementing the range register mechanism described above.

In an example, data stored in the memory array 342 for which the read-once indicator 352 is set is associated with a trusted execution environment instance, which may be an enclave or a trust domain as defined by the trusted execution environment architecture in use. Trusted execution environment memory may be the primary target for read-once protection because it contains data that an attacker would seek to cause a trusted execution environment instance to consume in a stale form. The read-once mechanism described herein is not inherently limited to trusted execution environment memory and may be applied to any memory region for which the freshness guarantee provided by read-once semantics is required. The designation of data as associated with a trusted execution environment instance on the memory device side, captured by the read-once indicator 352, corresponds to the designation on the processor side by which a trusted execution environment module assigns the read-once memory type to a region of the memory address space. Illustratively, the trusted execution environment module designates the region, the memory controller 302 marks cache lines fetched from that region with the read-once attribute and the memory controller 302 issues write-backs with a read-once indication, and the memory device control circuit 350 stores the data with the read-once indicator 352 set, all for data associated with the trusted execution environment instance.

In an example, the memory device control circuit 350 sets the read-once indicator 352 in response to receiving a write operation comprising an indication that the data unit is to be designated as read-once. For example, when the memory controller 302 issues a write-back of a cache line designated with the read-once attribute, the memory controller 302 includes an indication of read-once semantics in the write command transmitted to the memory device 304 via the memory interface 310. The indication may be encoded as a bit in the write command carried on the command and address bus of the memory interface 310, for example as a reserved bit within the DRAM write command encoding. The memory device control circuit 350 receives the write command, detects the indication, stores the data in the memory array 342, sets the read-once indicator 352 for the written data unit, and sets the validity indicator 351 to valid.

In an example, the memory device control circuit 350 is configured to verify the integrity of the indication that the data unit is to be designated as read-once. The integrity verification may be performed by at least one of a parity check computed over the command encoding, an error correcting code check applied to the command, or a message authentication code check computed over the command and associated data. If the integrity verification fails, the memory device control circuit 350 may reject the write operation or treat it as a conventional write operation without setting the read-once indicator 352. The integrity check can protect against an entity that has interposed a device on the memory bus from flipping the read-once indication bit in the write command: even if the interposing entity can modify individual signal states on the command and address bus. The integrity check allows the memory device control circuit 350 to detect that the command encoding has been altered.

In an example, the memory device control circuit 350 is configured to set the read-once indicator 352 for write operations targeting a region of the memory array 342 that has been configured as a read-once region, without requiring an explicit per-write indication in the write command. The region of the memory array 342 may be configured as a read-once region via a memory configuration protocol, for example through mode register settings applied to the memory device 304 during system initialization. Any write operation targeting an address within the preconfigured read-once region causes the memory device control circuit 350 to set the read-once indicator 352 for the written data unit, regardless of whether the write command carries an explicit indication. It is to be noted that the explicit designation mechanism and the implicit region-based designation mechanism are not mutually exclusive. The memory device 304 may support both simultaneously, so that a preconfigured read-once region applies read-once semantics to all writes within that region while explicit indications in write commands may designate individual data units in other regions. The two designation paths together can provide flexibility in system configuration.

In operation, the memory controller 302 may determine which cache lines carry the read-once attribute based on the memory type assigned to the corresponding region of the memory address space. When the memory controller 302 issues a write-back of a cache line designated with the read-once attribute, the memory controller 302 may include an indication of read-once semantics in the write command. The memory device control circuit 350 receives the indication and sets the read-once indicator 352, implementing the explicit designation. Alternatively, where the corresponding region of the memory array 342 is preconfigured as a read-once region, the memory device control circuit 350 may apply read-once semantics to all writes within that region regardless of whether the write command carries an explicit indication. In the implicit case, the memory controller 302 may or may not include the indication in the write command. The memory device control circuit 350 will set the read-once indicator 352. The two paths, i.e., explicit per-write indication and implicit region-based preconfiguration, can provide complementary mechanisms for communicating the read-once designation from the processor 301 to the memory device 304 across the memory interface 310.

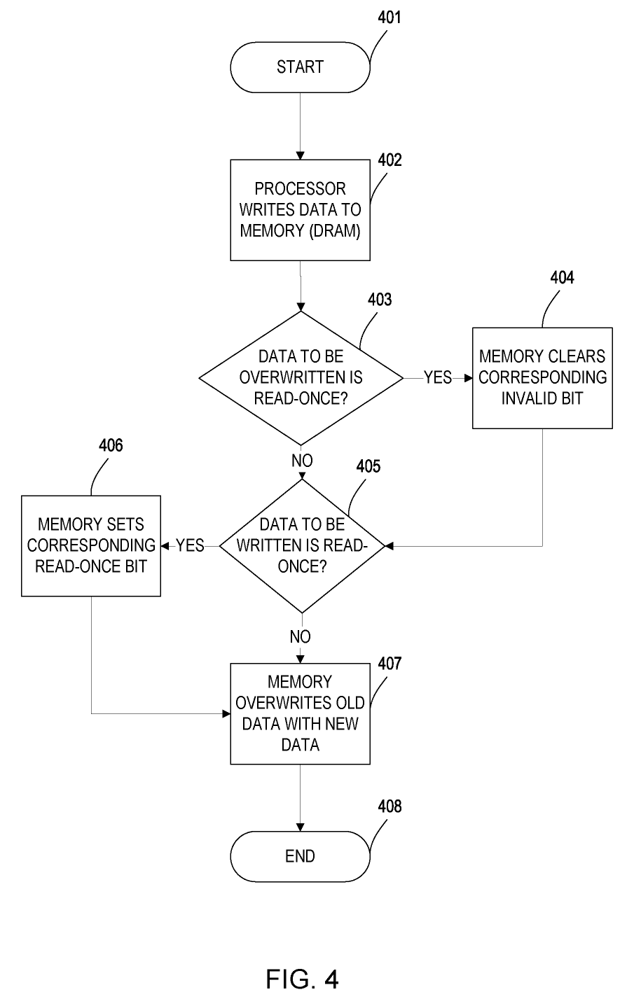

FIG. 4 illustrates an example flow chart in accordance with various aspects described herein. The flow chart may be implemented by the system described in accordance with FIG. 3. The flow chart may represent an example the behavior of the memory device 304 when the processor 301 writes data to the memory device 304. The flow begins at a start state 401 and proceeds to a first operation 402 in which the processor 301 issues a write operation directed to an address in the memory device 304. Upon receiving the write operation, the memory device control circuit 350 evaluates the state of the read-once indicator 352 associated with the data unit currently stored at the target address, which corresponds to the data unit that is to be overwritten according to the write operation, by proceeding to a first decision 403. The first decision 403 may involve the memory device control circuit 350 determining whether the data to be overwritten is designated as read-once. If the read-once indicator 352 for the data unit currently stored at the target address is set, the memory device control circuit 350 proceeds to an operation 404 in which the memory device control circuit 350 may clear the validity indicator 351 associated with that data unit before proceeding to evaluate the new data. Clearing the validity indicator 351 may correspond to changings its invalid state to valid state. So, the memory device control circuit 350 sets the validity indicator 351 to indicate that the data is valid before proceeding to evaluate the new data. If the read-once indicator 352 is not set, the memory device control circuit 350 proceeds directly to the second decision without modifying the validity indicator 351.

Following the first decision 403 and the clearing of the validity indicator 351 at operation 404 where applicable, the memory device control circuit 350 proceeds to a second decision 405 that determines whether the data to be written is to be designated as read-once. The second decision 405 evaluates whether the incoming write operation comprises an indication that the data unit is to be designated as read-once, either through an explicit indication encoded in the write command received via the memory interface 310 or through the implicit mechanism by which the target address falls within a region of the memory array 342 that has been preconfigured as a read-once region. If the second decision 405 is affirmative, the memory device control circuit 350 proceeds to an operation 406 in which the memory device control circuit 350 sets the read-once indicator 352 for the data unit at the target address, and then proceeds to overwrite the stored data. If the second decision 405 is negative, the memory device control circuit 350 proceeds to overwrite the stored data without setting the read-once indicator 352.

Following the evaluation of the second decision 405 and the conditional setting of the read-once indicator 352 at operation 406, the memory device control circuit 350 proceeds to an operation 407 in which the memory device control circuit 350 overwrites the data previously stored at the target address in the memory array 342 with the new data carried by the write operation. The flow then proceeds to an end state 408.

Upon completion of the write operation, the validity indicator 351 associated with the target data unit is in the valid state, considering that it has been set to valid at operation 404 if it was previously in the invalid state, or having remained valid if the first decision 403 was negative. The read-once indicator 352 further reflects the designation of the new data, having been set at operation 406 if the second decision 405 was affirmative or remaining unset otherwise. Every write operation can therefore result in a data unit that is in the valid and readable state, with the read-once indicator 352 accurately reflecting whether the newly written data is subject to single-read enforcement.

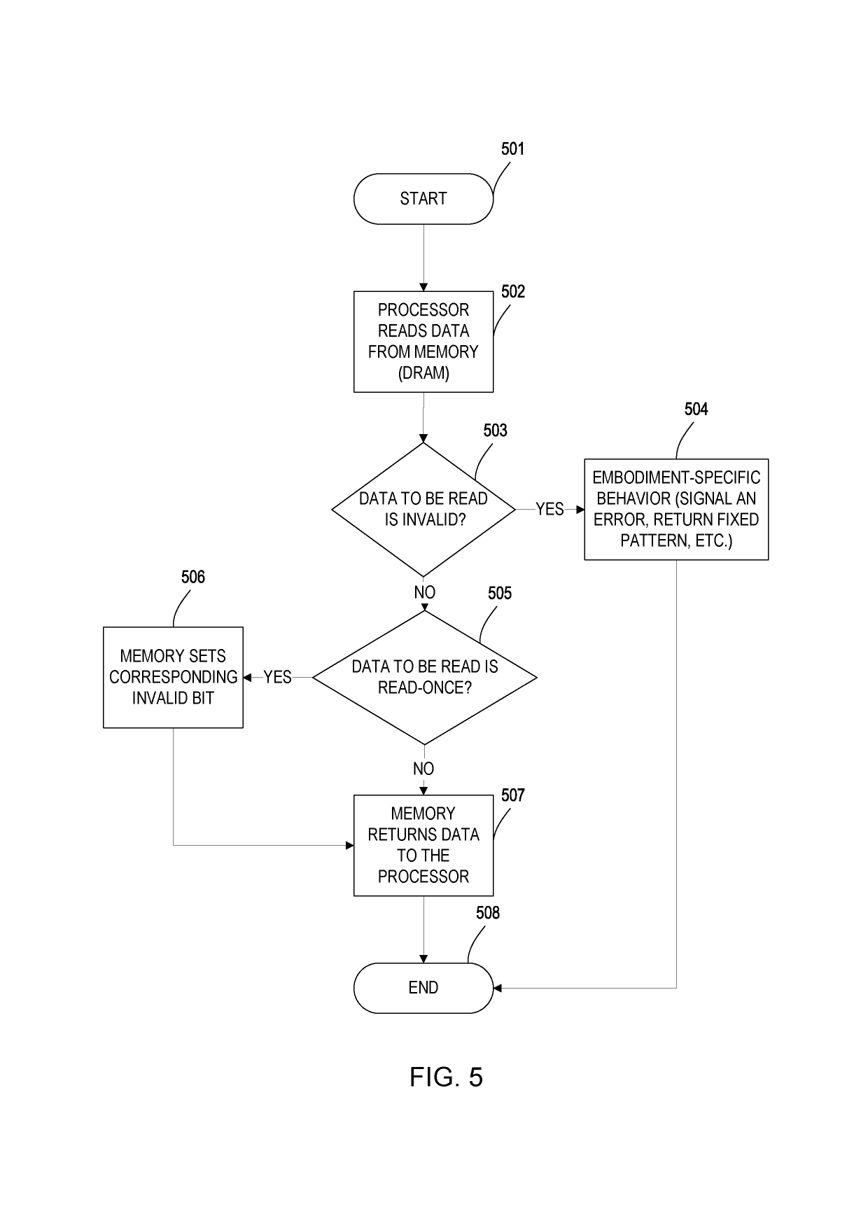

FIG. 5 illustrates an example flow chart in accordance with various aspects described herein. The flow chart may be implemented by the system described in accordance with FIG. 3. The flow chart may represent an example the behavior of behavior of the memory device 304 when the processor 301 reads data from the memory device 304. The flow begins at a start state 501 and proceeds to a first operation 502 in which the processor 301 issues a read operation directed to an address in the memory device 304. Upon receiving the read operation, the memory device control circuit 350 proceeds to a first decision 503 that determines whether the data unit at the target address is in the invalid state by evaluating the validity indicator 351 associated with that data unit. The first decision 503 is evaluated before any data is returned to the processor 301, so that the state of the validity indicator 351 governs the subsequent behavior of the memory device control circuit 350 in all cases.

If the first decision 503 determines that the validity indicator 351 indicates that the data is invalid, the memory device control circuit 350 proceeds to an operation 504 in which the memory device control circuit 350 performs embodiment-specific behavior in response to the read operation. In one embodiment, the memory device control circuit 350 outputs an error signal to the processor 301 via the memory interface 310. In another embodiment, the memory device control circuit 350 outputs a predetermined data pattern to the processor 301, the predetermined data pattern preferably being an all-zeros pattern. In both embodiments, the stored data is not returned to the processor 301, and the flow proceeds to an end state 508 without further modification of the validity indicator 351 or the read-once indicator 352. The receipt by the memory controller 302 of an error signal or a predetermined data pattern in response to a read targeting a data unit for which read-once semantics apply indicates that the validity indicator 351 was in the invalid state at the time of the read, which under correct system operation indicates that a write-back directed at that address was not committed by the memory device 304.

If the first decision 503 determines that the validity indicator 351 indicates that the data is valid, the memory device control circuit 350 proceeds to a second decision 505 that determines whether the data unit at the target address is designated as read-once by evaluating the read-once indicator 352. If the second decision 505 determines that the read-once indicator 352 is set, the memory device control circuit 350 proceeds to an operation 506 in which the memory device control circuit 350 sets the validity indicator 351 to the invalid state, and then proceeds to an operation 507 in which the memory device control circuit 350 returns the stored data to the processor 301 via the memory interface 310. The setting of the validity indicator 351 to the invalid state at operation 506 and the return of the data at operation 507 together may constitute the atomic compound behavior by which the memory device control circuit 350 outputs the data and renders the data unavailable for a subsequent read operation, as such no interval exists between the invalidation and the data return during which a second read could obtain the data while the validity indicator 351 remains valid. If the second decision 505 determines that the read-once indicator 352 is not set, the memory device control circuit 350 proceeds directly to operation 507 and returns the data to the processor 301 without modifying the validity indicator 351, because the data unit is not subject to read-once semantics. The flow then proceeds to the end state 508 in both cases.

When the processor 301 and the memory device 304 operate together as described with reference to FIG. 3, the combined system can enforce a mutual exclusion invariant with respect to data designated as read-once, such that at any point in the operation of the system, a data unit designated as read-once is valid in at most one of the cache hierarchy of the processor 301 or the memory array 342 of the memory device 304. When the memory device 304 holds a valid copy, that is, the validity indicator 351 is in the valid state, no copy of that data unit is held in the cache hierarchy with the read-once attribute set. When the processor 301 issues a read operation and the memory device control circuit 350 returns the data and sets the validity indicator 351 to invalid, the cache hierarchy holds the sole valid copy. When all cached copies are evicted and the memory controller 302 issues a write-back, the memory device control circuit 350 stores the data, sets the read-once indicator 352, and sets the validity indicator 351 to valid, so that the memory device 304 again holds the sole valid copy.

In a first attack scenario, assuming a write-back issued by the memory controller 302 in the fourth step of the lifecycle, the write-back that follows the eviction of the last cached copy of a read-once data unit. If an interposing device on the memory bus drops this write-back, the memory device 304 does not receive the write command and retains the state it held after the initial read. Accordingly, the validity indicator 351 remains in the invalid state, as set by the memory device control circuit 350 at operation 506. Any subsequent read operation issued by the memory controller 302 to the memory device 304 targeting that address causes the memory device control circuit 350 to evaluate the validity indicator 351 at decision 503, determine that the data is invalid, and proceed to operation 504, returning an error signal or a predetermined data pattern rather than the stale stored data. The processor 301 cannot consume stale data from the memory device 304 because the memory device control circuit 350 will not return stored data while the validity indicator 351 is in the invalid state, regardless of what data is stored in the memory array 342 at that address.

In a second attack scenario, assuming an attacker that seeks to drop a write operation targeting a data unit that the processor 301 has not yet read, that is, a data unit for which the validity indicator 351 is currently in the valid state and the read-once indicator 352 is set. The processor microarchitecture requires that the memory controller 302 read data from the memory device 304 before writing back modified data. Correspondingly, a write-back is issued only upon eviction of a cache line that was previously fetched from the memory device 304 by a read operation. The read operation causes the memory device control circuit 350 to set the validity indicator 351 to invalid at operation 506 before any write-back can occur. Therefore, at the time any write-back targeting that address is issued, the validity indicator 351 is already in the invalid state. If the attacker drops the write-back, the memory device 304 retains the invalid state. Any subsequent read targeting that address proceeds through decision 503 and receives the embodiment-specific invalid response at operation 504. The attacker cannot cause the processor 301 to consume the pre-read data because the memory device control circuit 350 invalidated that data upon the read that preceded the write-back.

The write-back policy implemented by the memory controller 302 may be configured to satisfy an if-and-only-if condition with respect to the validity of data in the cache hierarchy. The write-back is issued if and only if the data unit designated with the read-once attribute becomes invalid in all caches within the cache hierarchy. Correspondingly, the last remaining copy is evicted. The "if" direction ensures that when all cached copies are discarded, the memory device 304 receives the data and a valid copy is restored in the memory array 342, such that no window exists during which no valid copy exists anywhere in the system. The "only if" direction ensures that the memory controller 302 does not issue a write-back while a valid copy remains in the cache hierarchy, such that issuing a write-back while retaining a cached copy would result in both the cache hierarchy and the memory device 304 holding valid copies of the same read-once data unit simultaneously, which would violate the mutual exclusion invariant and potentially permit the memory device 304 to serve stale data after a subsequent modification in the cache hierarchy.

If the memory controller 302 receives an error signal or a predetermined data pattern from the memory device control circuit 350 in response to a read operation targeting a read-once data unit, this response indicates that the validity indicator 351 was in the invalid state at the time of the read. Under correct system operation, in which the mandatory write-back policy is maintained and no interfering device is present on the memory bus, this condition should not arise, i.e., write-back issued upon eviction of the last cached copy restores the validity indicator 351 to the valid state before any subsequent read from the memory device 304 is necessary. Receipt of the invalid response therefore constitutes a strong indicator that a write-back directed at that address was not committed by the memory device 304, which is, the write-back was dropped by an interposing device. Upon detecting this condition, the processor 301 or system firmware may terminate the trusted execution environment instance associated with the affected memory region, generate a security event log entry, or halt the affected system component. The invalid response mechanism thus provides not only passive protection against stale data consumption but also an active detection signal that can trigger a system-level security response.

The enforcement of read-once semantics at the interface between the processor 301 and the memory device 304 may require extensions to the memory interface specification governing the memory bus between the processor 301 and the memory device 304. The write command carried on the command and address bus may require an extended encoding to carry the indication of read-once semantics that the memory device control circuit 350 evaluates at decision 405 when determining whether to set the read-once indicator 352. The response protocol of the memory device 304 may have the ability to communicate the state of the validity indicator 351 to the memory controller 302, either by asserting an error signal or by encoding an invalid-data indication in the data returned on the data bus, so that the memory controller 302 can detect the condition described above. It is to be noted that these extensions may require changes to the memory interface standards that define the command and address bus encoding and the response protocol between processor memory controllers and memory devices, such as the standards defined by JEDEC for DDR memory interfaces.

While the preferred granularity for the read-once indicator 352 and the validity indicator 351 can be a cache line of 64 bytes, matching the granularity at which the processor 301 transfers data to and from the memory device 304 via the memory interface 310, the read-once indicator 352 and the validity indicator 351 may be maintained at other granularities. A coarser granularity, such as a multiple of the cache line size, reduces the metadata storage overhead within the memory device 304 at the cost of applying read-once semantics to a larger region of the memory array 342 per indicator, which may cause read-once enforcement to affect data units that share an indicator with the targeted data unit. A finer granularity, such as a sub-cache-line unit, increases the precision with which read-once semantics can be applied but increases the metadata storage overhead and may require corresponding changes to the memory interface 310 to transfer indicator state at the finer granularity

In multi-socket systems, in which a plurality of processors are interconnected and share access to the memory device 304, the last remaining copy of a read-once cache line may reside in a cache on a processor socket different from the socket that originally fetched the data from the memory device 304. The inter-socket coherence fabric must be read-once-aware in order to enforce the mutual exclusion invariant across sockets: the fabric must ensure that the mandatory write-back is issued by the socket holding the last remaining copy, regardless of which socket that is.

The primary copy mechanism described with reference to FIG. 3 is applicable to multi-socket systems in two respects. First, the cache holding the primary copy designation is responsible for issuing the write-back upon eviction of the last remaining copy, as described above. Second, the cache holding the primary copy designation may be responsible for responding to snoop requests from other sockets and for supplying the cache line via socket-to-socket transfer to a requesting socket, without issuing a read to the memory device 304. This can be necessary because the validity indicator 351 is in the invalid state while the cache hierarchy holds the sole valid copy, and a read to the memory device 304 would not return valid data. Upon eviction of the primary copy while other copies remain in the shared state on other sockets, the primary copy designation may be transferred across the inter-socket fabric to a cache on another socket holding a copy of the cache line, maintaining both write-back responsibility and snoop response responsibility continuously. Additionally, or alternatively, a further mechanism may be used, in which read operations targeting a read-once memory region are always issued as read-for-ownership operations, causing the memory controller 302 to acquire the cache line in the exclusive or modified state rather than the shared state. Under this mechanism, at most one socket holds a cached copy of a read-once cache line at any time, eliminating shared-state multiplicity across sockets and removing the need for both socket-to-socket data transfer of read-once cache lines and write-back tracking across multiple copies. When the exclusive copy is evicted, the memory controller 302 issues the write-back to the memory device 304 directly, without requiring primary copy designation transfer or inter-socket coordination.

The explicit designation mechanism, in which the memory controller 302 includes an indication of read-once semantics in the write command, and the implicit designation mechanism, in which the memory device control circuit 350 applies read-once semantics to all writes targeting a preconfigured region of the memory array 342, may coexist within the same memory device 304 and the same system. Illustratively, a region of the memory array 342 may be preconfigured as a read-once region via the memory configuration protocol, so that all writes to that region automatically cause the memory device control circuit 350 to set the read-once indicator 352, while individual write operations targeting addresses outside the preconfigured region may carry explicit indications to designate specific data units as read-once.

The behavior of the memory device control circuit 350 when the validity indicator 351 is in the invalid state and a read operation is received may be configured or selected at system initialization. In one embodiment, the memory device control circuit 350 asserts an error signal via the memory interface 310, which may trigger an immediate exception or interrupt in the processor 301 upon receipt by the memory controller 302. In another embodiment, the memory device control circuit 350 returns a predetermined data pattern, preferably an all-zeros pattern, which requires the memory controller 302 or the trusted execution environment instance to detect the invalid condition by comparing the received data against the known pattern or by examining a status indicator returned alongside the data. The choice between the error signal embodiment and the predetermined data pattern embodiment may depend on the error handling architecture of the processor 301, such that a processor 301 whose memory controller 302 implements hardware exception generation upon receipt of a memory error signal may prefer the error signal embodiment for immediacy of detection, while a processor 301 whose trusted execution environment runtime performs explicit data validation may prefer the predetermined data pattern embodiment.

The attack model addressed by the embodiments described herein is a memory interposer whose capability is limited to holding individual bus signals in a high or low state for a duration spanning multiple clock cycles. This capability is sufficient to cause the memory device 304 to ignore write commands, as described with reference to FIG. 2, but does not extend to active protocol emulation or full bus interception with command substitution. More sophisticated interposing devices, such as field-programmable gate array based active interposers capable of receiving, modifying, and re-transmitting commands in full conformance with the memory interface protocol, may require additional countermeasures.

The embodiments described herein are illustrative of the principles of the present disclosure and are not intended to limit the scope of protection, which is defined by the appended claims. The memory device 304 and the processor 301 may be implemented in any semiconductor technology and are not limited to any specific dynamic random access memory standard, memory interface specification, or processor microarchitecture. The read-once indicator 352, the validity indicator 351, and the memory device control circuit 350 may be implemented using any combination of digital logic, embedded memory, and state machine architecture that provides the functional behaviors described herein. The memory interface 310 may conform to any current or future memory interface standard that can be extended to carry the read-once indication in write commands and to communicate the state of the validity indicator 351 in read responses, as described with reference to FIG. 4 and FIG. 5 respectively.

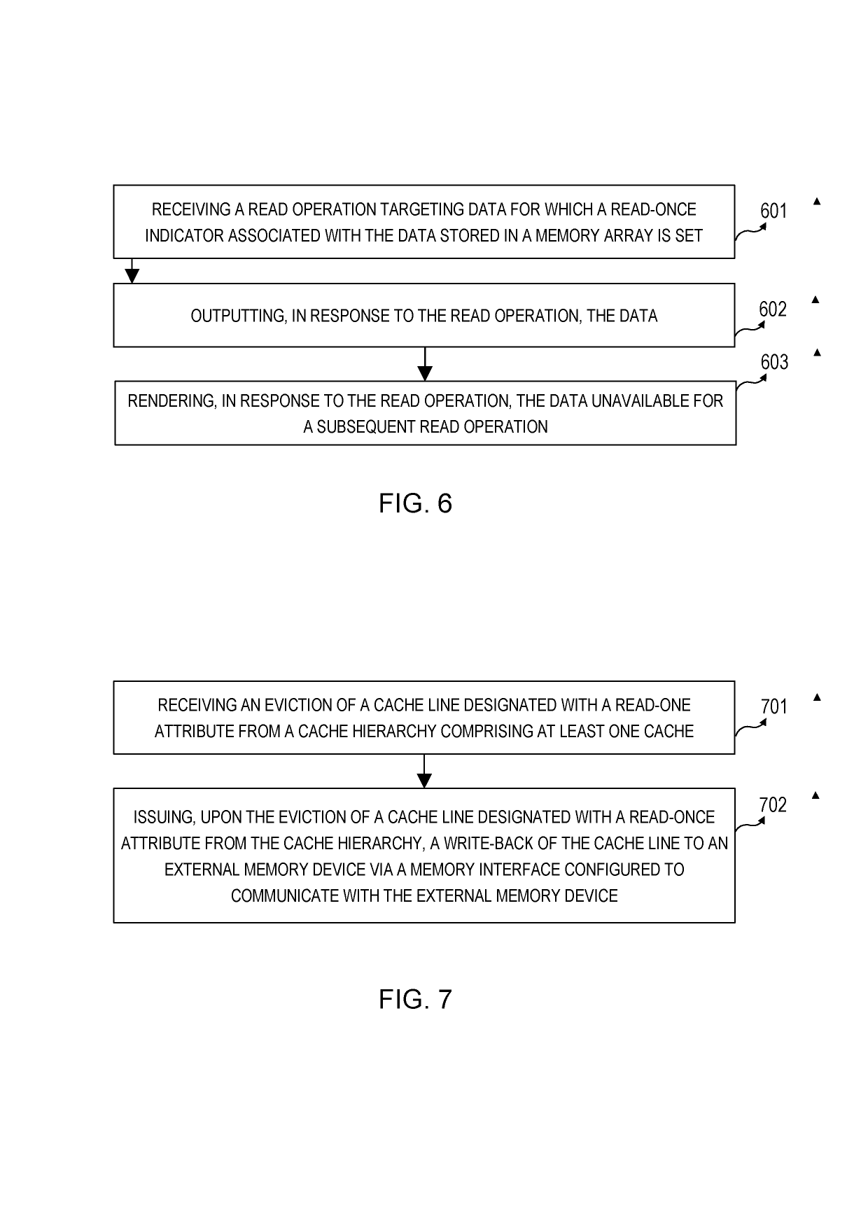

FIG. 6 shows an example of a method. The method may include: receiving 601 a read operation targeting data for which a read-once indicator associated with the data stored in a memory array is set; outputting 602, in response to the read operation, the data; and rendering 603, in response to the read operation, the data unavailable for a subsequent read operation. A non-transitory computer-readable medium may include instructions which, if executed by a processor, cause the processor to perform the method.

FIG. 7 shows an example of a method. The method may include: receiving 701 an eviction of a cache line designated with a read-one attribute from a cache hierarchy comprising at least one cache; and issuing 702, upon the eviction of a cache line designated with a read-once attribute from the cache hierarchy, a write-back of the cache line to an external memory device via a memory interface configured to communicate with the external memory device. A non-transitory computer-readable medium may include instructions which, if executed by a processor, cause the processor to perform the method.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more."

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of a memory device including: a memory array configured to store data; and a control circuit coupled to the memory array and configured to, in response to a read operation targeting data for which a read-once indicator associated with the data stored in the memory array is set: output the data; and render the data unavailable for a subsequent read operation.

Example 2 may include the subject matter of example 1, wherein the data stored in the memory array is organized in data units of a predetermined granularity, and wherein a respective read-once indicator is associated with each data unit. Preferably, each data unit is a cache line of 64 bytes.

Example 3 may include the subject matter of any one of examples 1 to 2, may further include a validity indicator associated with the data stored in the memory array, wherein the control circuit is configured to render the data unavailable for the subsequent read operation by setting the validity indicator to indicate that the data is invalid.

Example 4 may include the subject matter of example 3, wherein the control circuit is configured to, in response to a write operation targeting data for which the validity indicator indicates that the data is invalid, set the validity indicator to indicate that the data is valid.

Example 5 may include the subject matter of any one of examples 3 to 4, wherein the control circuit is configured to, in response to a read operation targeting data for which the validity indicator indicates that the data is invalid, output an error signal to an entity that issued the read operation.

Example 6 may include the subject matter of any one of examples 3 to 4, wherein the control circuit is configured to, in response to a read operation targeting data for which the validity indicator indicates that the data is invalid, output a predetermined data pattern to an entity that issued the read operation. Preferably, the predetermined data pattern is an all-zeros pattern.

Example 7 may include the subject matter of any one of examples 1 to 6, wherein the read-once indicator is stored within the memory device as a bit, and wherein the read-once indicator is not externally accessible.

Example 8 may include the subject matter of any one of examples 1 to 7, wherein the control circuit is configured to set the read-once indicator in response to receiving a write operation including an indication that the data units is to be designated as read-once.

Example 9 may include the subject matter of example 8, wherein the indication that the data units is to be designated as read-once is encoded as a bit in a command associated with the write operation.

Example 10 may include the subject matter of any one of examples 8 to 9, wherein the control circuit is configured to verify integrity of the indication that the data units is to be designated as read-once. Preferably by at least one of a parity check, an error correcting code check, or a message authentication code check.

Example 11 may include the subject matter of any one of examples 1 to 7, wherein the control circuit is configured to set the read-once indicator for write operations targeting a region of the memory array, wherein the region of the memory array is configured as a read-once region. Preferably, the region is preconfigured via a memory configuration protocol.

Example 12 may include the subject matter of any one of examples 1 to 11, may further include an interface configured to expose a stored validity indicator to an external device.

Example 13 may include the subject matter of any one of examples 1 to 12, wherein the data for which the read-once indicator is set is associated with a trusted execution environment instance. Preferably, the trusted execution environment instance is an enclave or a trust domain.

Example 14 may include the subject matter of a processor including: a cache hierarchy including at least one cache; a memory interface configured to communicate with an external memory device that is external to the processor; and a controller coupled to the cache hierarchy and the memory interface and configured to upon eviction of a cache line designated with a read-once attribute from the cache hierarchy, issue a write-back of the cache line to the external memory device via the memory interface.

Example 15 may include the subject matter of example 14, wherein the controller is configured to issue the write-back regardless of a modification state of the cache line.

Example 16 may include the subject matter of any one of examples 14 to 15, wherein the read-once attribute is stored as a bit associated with each cache line in the cache hierarchy.

Example 17 may include the subject matter of any one of examples 14 to 16, wherein the controller is configured to, in response to a data request targeting a cache line for which the read-once attribute is set, and wherein at least one copy is held in the cache hierarchy, service the data request from the cache hierarchy without issuing a read request to the external memory device.

Example 18 may include the subject matter of example 17, wherein the controller is configured to service the data request by initiating a snoop operation directed to caches within the cache hierarchy and obtaining the cache line via a cache-to-cache transfer.

Example 19 may include the subject matter of any one of examples 14 to 18, wherein the controller is configured to operate the cache hierarchy according to a cache coherence protocol. Preferably, the cache coherence protocol is a MESI protocol.

Example 20 may include the subject matter of example 19, wherein the cache coherence protocol is configured to permit a cache line designated with the read-once attribute to be held in a shared state across a plurality of caches within the cache hierarchy, and the controller is configured to issue the write-back upon eviction of a last remaining copy of the cache line from the plurality of caches.

Example 21 may include the subject matter of example 20, wherein the controller is configured to designate one copy of the cache line held in the shared state as a primary copy, wherein a cache holding the primary copy is responsible for responding to snoop requests directed to that cache line and for issuing the write-back upon eviction of the primary copy.

Example 22 may include the subject matter of example 21, wherein the controller is configured to, upon eviction of the primary copy from a cache while at least one other copy of the cache line remains in the shared state, transfer the primary copy designation to another cache holding a copy of the cache line.

Example 23 may include the subject matter of any one of examples 14 to 22, wherein the controller is configured to designate the read-once attribute for cache lines corresponding to a region of a memory address space based on a memory type assigned to the region. Preferably, the read-once memory type is defined at an instruction set architecture level.

Example 24 may include the subject matter of example 23, may further include a range register configured to define a contiguous region of the memory address space as having the memory type corresponding to the read-once attribute.

Example 25 may include the subject matter of example 23, may further include an interface configured to allow a trusted execution environment module to assign the memory type to a region of the memory address space. Preferably, the trusted execution environment module is a trust domain extensions module.

Example 26 may include the subject matter of any one of examples 14 to 25, wherein the controller is configured to, when issuing the write-back, include an indication of read-once semantics in a write command transmitted to the external memory device via the memory interface.

Example 27 may include a computing system including the memory device of any one of examples 1 to 13 and the processor of any one of examples 14 to 26.

Example 28 may include the subject matter of a method including: receiving a read operation targeting data for which a read-once indicator associated with the data stored in a memory array is set; outputting, in response to the read operation, the data; and rendering, in response to the read operation, the data unavailable for a subsequent read operation.

Example 29 may include the subject matter of example 28, wherein the data stored in the memory array is organized in data units of a predetermined granularity, and wherein a respective read-once indicator is associated with each data unit.

Example 30 may include the subject matter of any one of examples 28 to 29, may further include a validity indicator associated with the data stored in the memory array, wherein the method includes rendering the data unavailable for the subsequent read operation by setting the validity indicator to indicate that the data is invalid.

Example 31 may include the subject matter of example 30, may further include, in response to a write operation targeting data for which the validity indicator indicates that the data is invalid, setting the validity indicator to indicate that the data is valid.

Example 32 may include the subject matter of any one of examples 30 to 31, may further include, in response to a read operation targeting data for which the validity indicator indicates that the data is invalid, outputting an error signal to an entity that issued the read operation.

Example 33 may include the subject matter of any one of examples 30 to 31, may further include, in response to a read operation targeting data for which the validity indicator indicates that the data is invalid, outputting a predetermined data pattern to an entity that issued the read operation.

Example 34 may include the subject matter of any one of examples 28 to 33, wherein the read-once indicator is stored within the memory device as a bit, and wherein the read-once indicator is not externally accessible.

Example 35 may include the subject matter of any one of examples 28 to 34, may further include setting the read-once indicator in response to receiving a write operation including an indication that the data units is to be designated as read-once.

Example 36 may include the subject matter of example 35, wherein the indication that the data units is to be designated as read-once is encoded as a bit in a command associated with the write operation.

Example 37 may include the subject matter of any one of examples 35 to 36, may further include verifying integrity of the indication that the data units is to be designated as read-once.

Example 38 may include the subject matter of any one of examples 28 to 34, may further include setting the read-once indicator for write operations targeting a region of the memory array, wherein the region of the memory array is configured as a read-once region.

Example 39 may include the subject matter of any one of examples 28 to 38, may further include exposing, via an interface, a stored validity indicator to an external device.

Example 40 may include the subject matter of any one of examples 28 to 39, wherein the data for which the read-once indicator is set is associated with a trusted execution environment instance.

Example 41 may include the subject matter of a method including: receiving an eviction of a cache line designated with a read-one attribute from a cache hierarchy including at least one cache; issuing, upon the eviction of a cache line designated with a read-once attribute from the cache hierarchy, a write-back of the cache line to an external memory device via a memory interface configured to communicate with the external memory device.

Example 42 may include the subject matter of example 41, may further include issuing the write-back regardless of a modification state of the cache line.

Example 43 may include the subject matter of any one of examples 41 to 42, wherein the read-once attribute is stored as a bit associated with each cache line in the cache hierarchy.

Example 44 may include the subject matter of any one of examples 41 to 43, may further include, in response to a data request targeting a cache line for which the read-once attribute is set, and wherein at least one copy is held in the cache hierarchy, servicing the data request from the cache hierarchy without issuing a read request to the external memory device.

Example 45 may include the subject matter of example 44, may further include servicing the data request by initiating a snoop operation directed to caches within the cache hierarchy and obtaining the cache line via a cache-to-cache transfer.

Example 46 may include the subject matter of any one of examples 41 to 45, may further include operating the cache hierarchy according to a cache coherence protocol.

Example 47 may include the subject matter of example 46, wherein the cache coherence protocol is configured to permit a cache line designated with the read-once attribute to be held in a shared state across a plurality of caches within the cache hierarchy, and the method further includes issuing the write-back upon eviction of a last remaining copy of the cache line from the plurality of caches.

Example 48 may include the subject matter of example 47, may further include designating one copy of the cache line held in the shared state as a primary copy, wherein a cache holding the primary copy is responsible for responding to snoop requests directed to that cache line and for issuing the write-back upon eviction of the primary copy.

Example 49 may include the subject matter of example 48, may further include, upon eviction of the primary copy from a cache while at least one other copy of the cache line remains in the shared state, transferring the primary copy designation to another cache holding a copy of the cache line.

Example 50 may include the subject matter of any one of examples 41 to 49, may further include designating the read-once attribute for cache lines corresponding to a region of a memory address space based on a memory type assigned to the region.

Example 51 may include the subject matter of example 50, may further include a range register for defining a contiguous region of the memory address space as having the memory type corresponding to the read-once attribute.

Example 52 may include the subject matter of example 50, may further include allowing, via an interface, a trusted execution environment module to assign the memory type to a region of the memory address space.

Example 53 may include the subject matter of any one of examples 41 to 52, may further include, when issuing the write-back, including an indication of read-once semantics in a write command transmitted to the external memory device via the memory interface.

Example 54 may include a non-transitory computer-readable medium including instructions which, if executed by a processor, cause the processor to perform the method of any one of examples 28 to 53.

What is claimed is:

1. A memory device comprising:
a memory array configured to store data; and
a control circuit coupled to the memory array and configured to, in response to a read operation targeting data for which a read-once indicator associated with the data stored in the memory array is set:
output the data; and
render the data unavailable for a subsequent read operation.

2. The memory device of claim 1, wherein the data stored in the memory array is organized in data units of a predetermined granularity, and wherein a respective read-once indicator is associated with each data unit.

3. The memory device of claim 1, further comprising a validity indicator associated with the data stored in the memory array, wherein the control circuit is configured to render the data unavailable for the subsequent read operation by setting the validity indicator to indicate that the data is invalid.

4. The memory device of claim 3, wherein the control circuit is configured to, in response to a write operation targeting data for which the validity indicator indicates that the data is invalid, set the validity indicator to indicate that the data is valid.

5. The memory device of claim 3, wherein the control circuit is configured to, in response to a read operation targeting data for which the validity indicator indicates that the data is invalid, output an error signal to an entity that issued the read operation.

6. The memory device of claim 3, wherein the control circuit is configured to, in response to a read operation targeting data for which the validity indicator indicates that the data is invalid, output a predetermined data pattern to an entity that issued the read operation.

7. The memory device of claim 1, wherein the control circuit is configured to set the read-once indicator in response to receiving a write operation comprising an indication that data units of the data is to be designated as read-once.

8. The memory device of claim 7, wherein the indication that data units of the data is to be designated as read-once is encoded as a bit in a command associated with the write operation.

9. The memory device of claim 1, wherein the control circuit is configured to set the read-once indicator for write operations targeting a region of the memory array, wherein the region of the memory array is configured as a read-once region.

10. A processor comprising:
a cache hierarchy comprising at least one cache;
a memory interface configured to communicate with an external memory device that is external to the processor; and
a controller coupled to the cache hierarchy and the memory interface and configured to, upon eviction of a cache line designated with a read-once attribute from the cache hierarchy, issue a write-back of the cache line to the external memory device via the memory interface.

11. The processor of claim 10, wherein the controller is configured to issue the write-back regardless of a modification state of the cache line.

12. The processor of claim 10, wherein the read-once attribute is stored as a bit associated with each cache line in the cache hierarchy.

13. The processor of claim 10, wherein the controller is configured to, in response to a data request targeting a cache line for which the read-once attribute is set, and wherein at least one copy is held in the cache hierarchy, service the data request from the cache hierarchy without issuing a read request to the external memory device.

14. The processor of claim 13, wherein the controller is configured to service the data request by initiating a snoop operation directed to caches within the cache hierarchy and obtaining the cache line via a cache-to-cache transfer.

15. The processor of claim 10, wherein the controller is configured to operate the cache hierarchy according to a cache coherence protocol, wherein the cache coherence protocol is configured to permit a cache line designated with the read-once attribute to be held in a shared state across a plurality of caches within the cache hierarchy, and the controller is configured to issue the write-back upon eviction of a last remaining copy of the cache line from the plurality of caches.

16. The processor of claim 15, wherein the controller is configured to designate one copy of the cache line held in the shared state as a primary copy, wherein a cache holding the primary copy is responsible for responding to snoop requests directed to that cache line and for issuing the write-back upon eviction of the primary copy.

17. The processor of claim 10, wherein the controller is configured to designate the read-once attribute for cache lines corresponding to a region of a memory address space based on a memory type assigned to the region.

18. The processor of claim 17, further comprising a range register configured to define a contiguous region of the memory address space as having the memory type corresponding to the read-once attribute.

19. A method comprising:
receiving a read operation targeting data for which a read-once indicator associated with the data stored in a memory array is set;
outputting, in response to the read operation, the data; and
rendering, in response to the read operation, the data unavailable for a subsequent read operation.

20. The method of claim 19, wherein the data stored in the memory array is organized in data units of a predetermined granularity, and wherein a respective read-once indicator is associated with each data unit.
